(19) United States
(12) Patent Application Publication
(10) Pub. No.: US 2006/0261999 A1
(43) Pub. Date: Nov. 23, 2006

(54) Universal remote

(76) Inventor: John Dan Mabry, Indianapolis, IN (US)

Correspondence Address: THOMSON LICENSING INC., PATENT OPERATIONS, PO BOX 5312, PRINCETON, NJ, 08543-5312, US

(21) Appl. No.: 10/567,719

(22) PCT Filed: Aug. 10, 2004
(86) PCT No.: PCT/US04/25897

§ 371 Date: Feb. 8, 2006

Related U.S. Application Data
(60) Provisional application No. 60/497,973, filed on Aug. 25, 2003.

(51) Int. Cl. G08C 19/12; H04L 17/02

(52) U.S. Cl. 341/176

(57) ABSTRACT

A universal remote control is disclosed that is easy to operate in an environment where sight regarding the remote is limited. The keypad of the remote is arranged into a plurality of groupings based on their functionality. The plurality of groupings includes a grouping for a power button, a grouping for each different appliance, a grouping for support functions for the appliances, a grouping for navigation keys, a grouping for volume/channel keys a grouping for number keys and a grouping for device functions. The layout of the keypad of the remote into specific groupings allows the user to learn to operate the remote quickly and easily without having to look at the remote for guidance, i.e., by feel alone.

### CROSS-REFERENCE TO RELATED APPLICATIONS

This application claims the benefit of U.S. Provisional Patent Application Ser. No. 60/497,973, entitled “Universal Remote” and filed Aug. 25, 2003, which is incorporated by reference herein in its entirety.

### FIELD OF THE INVENTION

The present invention pertains to the field of universal remote control for appliances.

### BACKGROUND OF THE INVENTION

It is now common practice to include a “multi-function” or “Universal” remote control (URC) hand held transmitter with many consumer products (also referred to herein as devices, apparatus or appliances) such as televisions, video cassette recorders (VCRs), digital video disk players (DVDs), satellite receivers, compact disk players, and audio systems, to name a few. The advantage of URC's is that the consumer can control not only the particular appliance with which it was sold (hereinafter referred to as “first” appliance), but the consumer can use the same device to control any number of other appliances (hereinafter referred to as “different” appliance).

Because of the need to be able to control so many different appliances, i.e., TV, VCR, DVD, cable, satellite, stereo and others, it has become common practice to provide one or more “soft” keys on the URC to select the device that is being addressed by the remote control at a particular time. Each time such soft key is pressed, the URC is programmed to toggle between controlling each different appliance. In the case of one such soft key, if the URC is currently controlling the TV, pressing such soft key once may toggle the control to the VCR, whereas pressing it twice may toggle it to the DVD. In the case of separate soft keys for each type of appliance, the URC may have one soft key for toggling the URC to control the TV, and another soft key to toggle the URC to control a first VCR, and yet another to toggle the URC to control a second VCR, and so on.

Whether a single soft key is used to cause the URC to toggle between controlling different appliances or one soft key is provided for each type of different appliance, the person using the URC may be operating the URC in an environment where sight regarding the remote is limited. Such environment may include a darkened room. In some cases, when the URC is operated in a darkened room the user may inadvertently press a TV soft key rather than a VCR soft key, and become confused, frustrated and annoyed.

### SUMMARY OF THE INVENTION

The present invention is directed to a universal remote control that is easy to operate in an environment where sight regarding the remote is limited. The keypad of the remote is arranged into a plurality of groupings based on their functionality. The plurality of groupings includes a grouping for a power button, a grouping for each different appliance, a grouping for support functions for the appliances, a grouping for navigation keys, a grouping for volume/channel keys, a grouping for number keys and a grouping for device functions. The layout of the keypad of the remote into specific groupings allows the user to learn to operate the remote quickly and easily without having to look at the remote for guidance, i.e., by feel alone.

### BRIEF DESCRIPTION OF THE DRAWINGS

The invention is hereinafter described in detail with reference to the accompanying drawings, in which:

FIGS. 1A-1B depict a top view and side view of one embodiment of the universal remote control of the present invention.

### DETAILED DESCRIPTION

The present invention is directed to a universal remote control that is easy to operate in an environment where sight regarding the remote is limited. More specifically it deals with the issue of operating said remote in an environment where sight regarding the remote is limited, such as, for example, in a darkened room when watching TV.

This keypad of the universal remote control is designed to work with the overall form of the device to allow the user to learn to use this remote quickly and easily. The end result being that the user may operate multiple devices with this remote without having to look at the remote for guidance, i.e., by feel alone.

All remotes in one way or another attempt to guide the user to easier operation of the devices they control. Such is the point of the remote control in the first place. They all place the buttons in a manner that is believed provides the optimal location for end users operation. Additionally, the shape of the buttons may be used to tactilely guide the user through the functions of the remote.

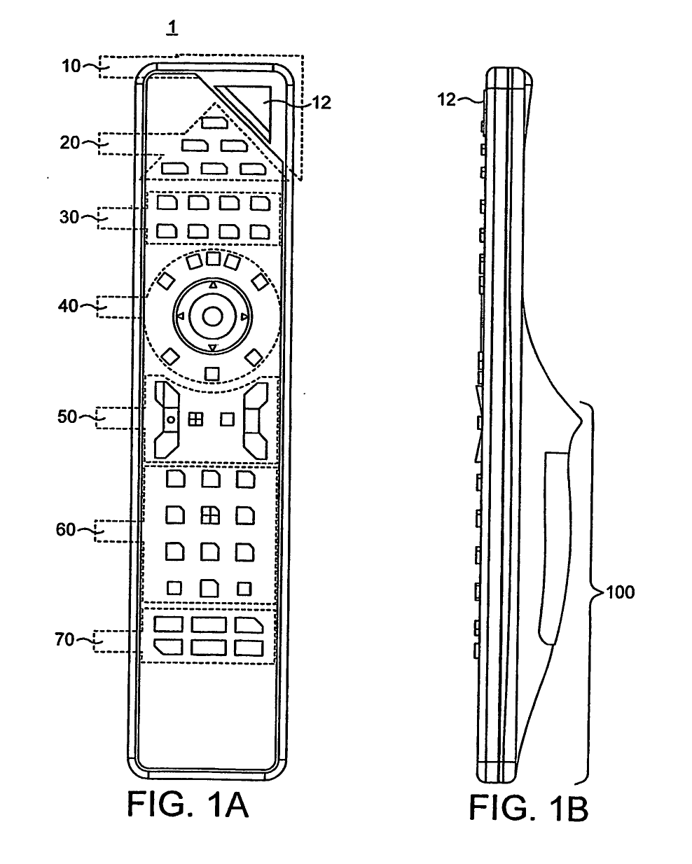

Referring to FIG. 1A, the keypad of the remote 1 is arranged into a plurality of groupings based on their functionality. The plurality of groupings includes at least a grouping for a power button 10, a grouping for each different appliance 20, a grouping for support functions for the appliances 30, a grouping for navigation keys 40, a grouping for volume/channel keys 50, a grouping for number keys 60 and a grouping for device functions 70. The layout of the keypad of the remote 1 into specific groupings allows the user to learn to operate the remote quickly and easily without having to look at the remote for guidance, i.e., by feel alone.

Referring to FIG. 1B, the functional purpose of the remote 1 is to strategically place the hand (not shown) in the region 100 of the remote so that the thumb will be in the best position to effectively and easily reach the most often used keys of the remote. The keys themselves are separated out into groupings 10, 20, 30, 40, 50, 60, 70 based on their functionality or “zones.

A grouping for the power button 10 may be located in the top right corner of the remote 1. The power button grouping 10 typically contains only one button having the function to turn on or off whichever device may currently be selected. The power button keypad 12 may be considered the single most important key on the remote 1 in terms of function. For this reason, the power button keypad 12 is the topmost key on the remote 1 and is grouped by itself.

The power button keypad 12 may have, for example, a triangular shape by essentially mimicking an angled cut through the top of the remote. The meaning behind the triangular shape is that the power button keypad 12 appears as a physical part of the core case top form. A fitting definition for a button having a functionality that is at the core of the remote 1. Other shapes for the power button keypad 12, such as, for example, square, round, oval and rectangular are also contemplated.

The power button keypad 12 may be positioned to the right of the centerline representing the right hand corner of the remote 1. Such positioning is intended for ease of use by users that will be right handed, however the power button keypad 12 may alternatively be positioned to the left of the centerline for left handed users as well.

The power button keypad 12 is the largest single key on the remote 1. This serves two purposes. First, the power button keypad 12 is, visually, the most prominent key on the remote 1, since its function is the most important to the remote 1. Second, the power button keypad 12 is, tactilely, the most prominent key on the remote. The power button keypad is the thinnest button on the remote (FIG. 1B). This promotes its unity in the general form of the remote 1, both visually and tactilely, and also decreases the chance of accidentally actuating this key. Along the slanted side of the remote 1, the case top rolls down into the remote case. This gives the thumb a comfortable place to rest when the power button keypad 12 is depressed. All of these features produce a power button keypad 12 that is unmistakable to the touch and easily discerned from the others by sight.

A grouping of keypads 20 for each different appliance may be located near the top center of the remote 1. The appliance keypads 20 are keypads that are used to select individual components (e.g., VCRs, DVD players CD players, among others) or devices to let the remote talk to those devices individually when selected. The appliance keypads 20 may be considered the second most important functional grouping. As such, the appliance keypads 20 are the second grouping on the remote 1 from top to bottom. The appliance keypads 20 may have a boxy or rectangular shape, to provide a clear tactile outline for the user. For example, when there is an instance of multiple appliance keypads in a row the user can, by the shape, easily tell where one button ends and the next button begins. At the same time, this button shape provides a sense of continuity. As in a matrix or grid, the linear sides allow the user to sweep along a series of buttons by feel and define them as a row. Once a row is defined the user can use this reference point to sweep up or down to locate additional functions while still retaining a sense of location on the remote 1. The appliance keypads 20 may also have flat tops that are parallel to the case top, and also assist in this functionality.

The appliance keypads 20 may optionally be accentuated by 45 degree beveled edges. These edges may exist, for example, at the top right and lower left of all six buttons in this grouping. The beveled edge provides for a softer less “exact” feeling as the user moves their thumb from right to left. However the sharper corner in the upper left of the button provides for a positive feedback as the user moves their thumb from left to right. The purpose of this feature is to make the keys more distinguishable from left to right rather that from right to left. This feature is designed to counteract the natural tendency of the right-handed user to sweep the keys from right to left, and as the buttons are ordered in importance from left to right. The appliance keypads 20 may carry the extra bevel located at the bottom left to differentiate them tactilely from any similarly shaped buttons located below them on the remote.

The appliance keypads 20 maybe arranged in for example, a pyramid stacking arrangement. The pyramidal stacking arrangement may be implemented to provide a hierarchy for the devices they represent. Such a hierarchy is derived based on which devices that are most interacted with related to those whom are least interacted with. For example, the most used device is put at the top of the pyramid and is the only button in its row. The next two most used devices are placed in the row beneath the first row. And lastly the three next most used devices are placed in a row of their own below the first two rows. The reading order standard of western civilization, left to right, top to bottom, is widely used in this remote to denote the hierarchy of functions and the device key pyramid stacking exemplifies such. The appliance keypads 20 are not only ordered from most important at the top but also from left to right as well. Such an arrangement allows the user to intuitively locate and remember where specific appliance keypads are.

A grouping for support functions 30 for the appliances may be located just below the appliance keypad grouping 20. Due to the wide variety of device applications for the remote that may be called into service, it is important to have the remote support a variable function key structure. The grouping for support function 30 may be defined with zero function keys, 1 function key, 4 function keys, 6 function keys, and 8 function keys. By the strategic use of tooling procedures (pins forming the button holes that can be removed or added) and graphics, this grouping area may be used to accommodate these needs while still retaining symmetry and even visual weight. The support function keypads 30 may also employ the use of a beveled upper right corner for the reasons mentioned above.

A grouping for navigation keys 40 may be located centrally on the remote 1, just below the appliance support function keypads 30. The navigation keys 40 include direction keys such as, for example, UP, DOWN, LEFT, RIGHT keys surrounding a center circular core OK/SELECT key. The circular core OK/SELECT key may be surrounded by satellite keys shaped as, for example, squares and oriented in a radial fashion using the OK/SELECT key as a point of origin. Such an orientation gives each of the satellite keys a different feel while still maintaining a uniform shape.

A grouping for volume/channel keys 50 may be located below the grouping of navigation keys 40 to facilitate the relationship of theses two groupings. The volume/channel keys 50 may be rocker styled volume and channel controls being logically placed in an orientation of up equals “+” (plus) and down equals “−” (negative). To differentiate which button controls the volume and which controls the channel two, mirrored “C” shaped buttons may be used. These shapes allow the user to feel the most dramatic edges (upper left-bottom left for the left oriented Volume control and upper right bottom right for the right oriented Channel control). Additionally, volume “MUTE” and channel “GO BACK” keys may be located at the apex point of their related Channel or Volume “C” shaped buttons, creating a tactile triangle of related functionality.

A grouping for number keys 60 may be located below the grouping for volume/channel keys 50. The grouping for number keys 60 may be arranged using the aforementioned beveled edge convention.

A grouping for device functions 70 may be located below the grouping for the number keys 60. The device function keys 70 may have the traditional key layout for actuating, for example, “REVERSE”, “PLAY”, “FORWARD”, “RECORD”, “STOP”, and “PAUSE” functions associated with the various appliances to be addressed. The device function keys 70 may include a protective record bar located directly above, for example, the “RECORD” key and the beveled edges of the “RECORD” key and the “FORWARD” key. The protective record bar aids in preventing accidental recording making this button hard to actuate unless it is purposely done so. The beveled edges previously mentioned are applied to aid the user in navigating this zone tactilely.

Each of the key groupings 10, 20, 30, 40, 50, 60, 70 may have its own button scale, proportion, and where required for emphasis, shape, so as to combat tactile confusion between the different groupings. Additionally, the general spacing between keypads within a group is smaller than spacing between different groups to assist the user in detecting, by feel as well as visually, the separate groupings. Also, the spacing makes the grouping of specific keypads more obvious and separates the remote into smaller more visually digestible pieces.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A universal remote control, comprising:
a plurality keypads arranged in a plurality of groupings based on functionality, wherein the shape and location of the keypads in each grouping enable a user to operate the universal remote control.

2. The universal remote control of claim 1 wherein the plurality of groupings are selected from the group consisting of a grouping for a power button, a grouping for each different appliance, a grouping for support functions for the appliances, a grouping for navigation keys, a grouping for volume/channel keys a grouping for number keys and a grouping for device functions.

3. The universal remote control of claim 1 wherein keypad spacing between keypads within each grouping is smaller than keypad spacing between each of the plurality of groupings.

4. The universal remote control of claim 1 wherein keypads in adjacent groupings have different shapes.

5. The universal remote control of claim 1 wherein keypads in adjacent groupings have different sizes.

6. A universal remote control system, comprising;
at least one remotely controllable appliance; and
a universal remote control, wherein the universal remote control includes a plurality keypads arranged in a plurality of groupings based on functionality, wherein the shape and location of the keypads in each grouping enable a user to operate the universal remote control.

7. The universal remote control system of claim 6 wherein the plurality of groupings are selected from the group consisting of a grouping for a power button, a grouping for each different appliance, a grouping for support functions for the appliances, a grouping for navigation keys, a grouping for volume/channel keys a grouping for number keys and a grouping for device functions.

8. The universal remote control system of claim 6 wherein keypad spacing between keypads within each grouping is smaller than keypad spacing between each of the plurality of groupings.

9. The universal remote control system of claim 6 wherein keypads in adjacent groupings have different shapes.

10. The universal remote control system of claim 6 wherein keypads in adjacent groupings have different sizes.

11. The universal remote control system of claim 6 wherein the at least one remotely controllable appliance is selected from the group consisting of a television receiver, a video cassette recorder (VCRs), a digital video disk player (DVDs), a satellite receiver, a compact disk player, and an audio system.
